(19) United States
(12) Patent Application Publication
(10) Pub. No.: US 2010/0077047 A1
(43) Pub. Date: Mar. 25, 2010

(54) System and method for broadcasting messages to user sessions

(76) Inventor: Joseph Chyam Cohen, Burbank, CA (US)

Correspondence Address: Albert R. Ubieta;Torrey Pines Intellectual Property Group, P.C., No. 431, 2658 Del Mar Heights Road, Del Mar, CA, 92014, US

(21) Appl. No.: 12/586,607

(22) Filed: Sep. 23, 2009

Related U.S. Application Data
(60) Provisional application No. 61/099,469, filed on Sep. 23, 2008.

(51) Int. Cl. G06F 15/16; G06F 15/173

(52) U.S. Cl. 709/206; 709/224

(57) ABSTRACT

Methods, apparatus, systems and computer program product for broadcasting a message to multiple users in a terminal server environment. Messages can be sent from the administrator to one or more user sessions using a communication path such as a file, a pipe, a socket, or a system protocol, such as Mach messaging. By using such a communication path rather than a central messaging system daemon or driver, user sessions can remain isolated from one another and established boundaries between user sessions can be maintained.

### CROSS-REFERENCE TO RELATED APPLICATIONS

This application claims the benefit of provisional patent application Ser. No. 61/099,469, filed Sep. 23, 2008, which is incorporated by reference.

### FEDERALLY SPONSORED RESEARCH

Not applicable.

### SEQUENCE LISTING OR PROGRAM

Not applicable.

### FIELD OF THE INVENTION

The present invention relates to the field of computer networks. In particular, the present invention relates to methods, apparatus, systems and computer program product for broadcasting messages to user session within a terminal server environment.

### BACKGROUND

For enterprises large and small, consolidation of hardware and software is increasingly vital due to reasons of accessibility, reliability, data security, cost and the administration of applications and the network itself. Managing remote users, their computing experience and their access to networks is similarly crucial. Many different types of institutions have used terminal server applications to provide a computing environment and to address these issues, despite having varied institutional and computing objectives. For instance, educational institutions deploy computer networks to allow teachers, students and staff to connect remotely, thereby allowing increased productivity, easier access to information, rapid communication and, ultimately, enhanced learning opportunities. Government agencies are perhaps more concerned with data security, which is why terminal services always have been essential to their information technology infrastructures. Thin client and network deployments have been mandated in several agencies—this allows all operations to be performed centrally, and secures and monitors information that may have been sent or received. Commercial organizations, as well, benefit from deploying terminal servers so that data transmission can be managed and controlled; for example, by requiring users to access data through smart cards and biometrics, and allowing editing and review of the data only within a secure environment, or by certain identified users. And in the case of organizations of all types there is a growing need for network users to access information via mobile or handheld devices from remote locations.

Centralized computing results in cost savings, ease of administration and enhanced security. Since almost all the processing of an application is done on a central server, companies are not forced to continuously upgrade or replace client or user hardware to keep pace with the systems requirements of modern applications. Maintenance of applications is isolated to the application server and not each individual node, also reducing administrative overhead. Servers are usually located in secure data centers, reducing the risk of physical theft. Centralized malware and audit processes also facilitate enhanced security. In addition, replacing workstations with thin clients can reduce energy consumption, environmental costs, support cost, and hardware costs.

In many networks based on Unix-like systems, the system shell provides a central messaging system for displaying notifications to a user. In these systems, an administrator or an automated operating system agent broadcasts a message to a user or group of users by sending the message to a central messaging queue. The shell process periodically checks the central messaging queue to discern whether a new message for a user has been received, and if so, the message is copied and displayed to each user in the recipient group. However, in certain graphical environments, such as the Mac OS X environment, provided by Apple Inc. of Cupertino, Calif., a central messaging system for broadcast messages is not provided. As a result, client users in a networked graphical environment based on such a system cannot receive broadcast messages. Therefore, there exists a need for broadcasting a message to multiple users in a terminal server environment lacking a central messaging system. In addition, there exists a need for methods of delivering broadcast messages to users in a terminal server environment that offer better security and stability than offered by the known central messaging system shells.

### SUMMARY

The disclosed embodiments relate to methods, apparatus, systems and computer program product for broadcasting a message to multiple users in a terminal server environment. In a computing system supporting multiple user sessions, such as in a terminal server environment, messages can be sent from one user session, e.g. an administrator, to one or more other user sessions. For example, an administrator can be any user session executing on a host computing system that has privileges to communicate with one or more other user sessions executing on the same host computing system. A message sent by an administrator to a user session can be used to convey information relating to a wide variety of topics. For example, a message can be sent to all user sessions executing on the host computing system to inform the users that the system will be shutting down in a number of minutes or to disseminate an announcement, such as a warning relating to an emergency. A message also can be targeted to one or more specific users such as to inform a user that he is performing an illegal activity or that he has exceeded a system limitation, such as an amount of data that can be downloaded during a predetermined period of time.

Further, messages can be sent from the administrator to one or more user sessions through an available system message pathway. For example, a message can be sent from an administrator to one or more user sessions using a communication path such as a file, a pipe, a socket, or a system protocol, such as Mach messaging. By using such a communication path rather than a central messaging system daemon or driver, user sessions can remain isolated from one another and established boundaries between user sessions can be maintained. These embodiments result in enhanced security and stability compared with earlier methods. These and other advantages of the many aspects of the disclosed embodiments will become apparent from a review of the following description and corresponding figures.

### DRAWINGS

The accompanying drawings, which are incorporated herein and constitute a part of this specification, illustrate embodiments of the invention and together with the description serve to explain the principles of the invention.

FIG. 1 graphically depicts an exemplary computing system in which an administrator can send messages to one or more user sessions.

FIG. 2 is a flow chart of an exemplary process for broadcasting a message to one or more users in a multi-user environment.

### DETAILED DESCRIPTION

Exemplary embodiments of the present invention are now described in detail, including depiction of the hardware components which serve as the context for the process embodiments.

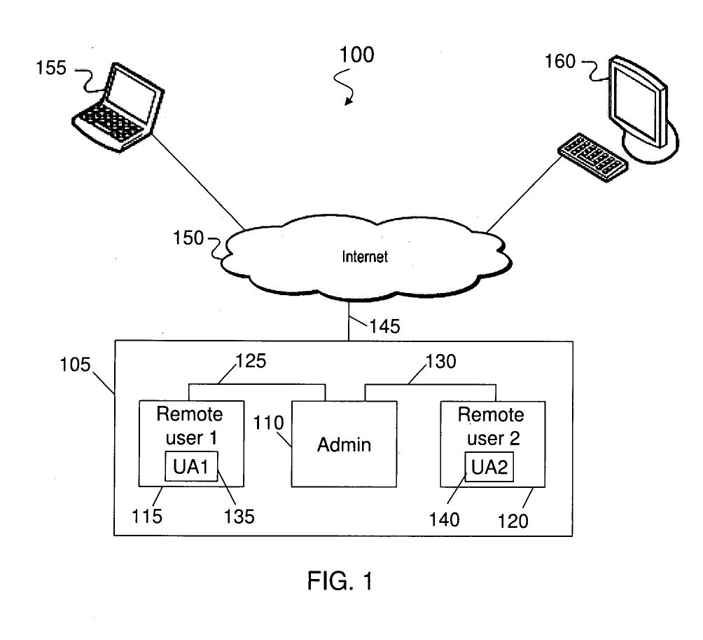

FIG. 1 shows an example computing system 100, in which an administrator can send messages to one more user sessions. A host computing system 105 can be any computing architecture that can support multiple user sessions, such as a desktop computer, a workstation, a laptop computer, a server, or an embedded computing system. Further, the host computing system 105 can be configured to execute an operating system that can support multiple user sessions. For example, the operating system can be a Mac OS provided by Apple Inc. of Cupertino, Calif., a Windows operating system provided by Microsoft Corporation of Redmond, Wash., a Linux operating system, or a custom operating system.

Multiple user sessions can be instantiated in the host computing system 105, such as an administrator session 110, a first remote user session 115, and a second remote user session 120. A remote user session can correspond to a remote system that interacts with the user session through a terminal server environment. The first remote user session 115 can correspond to a first remote system 155 and the second remote user session 120 can correspond to a second remote system 160. A remote system can be any computing architecture that can participate in a terminal server environment, including a desktop computer, a workstation, a laptop computer, a palm top computer, a server, a thin client, or an embedded computing system.

The administrator session 110 can be granted one or more privileges that exceed the privileges assigned to a user session, such as the ability to send messages to other user sessions and/or the ability to monitor one or more user sessions. The first remote user session 115 and the second remote user session 120 also can be assigned different permissions based on the user associated with each user session. Additionally, the administrator session 110 can have a communication path to each user session executing in the host computing system 105. The communication path is a physical channel over which a message can be transmitted from the administrator to one or more user sessions. For example, the administrator session 110 can communicate with the first remote user session 115 over the communication path 125 and the second remote user session 120 over the communication path 130. In some implementations, the communication path can be the same for two or more user sessions.

A user agent also can be associated with each user session instantiated in the host computing system 105. For example, a first user agent 135 can be associated with the first remote user session 115 and a second user agent 140 can be associated with the second remote user session 120. The user agent is an application that runs in the user session to facilitate communication, such as based on messages received from the administrator. The user agent is initialized and controlled by the computing system and/or the administrator. Thus, although the user agent exists within the context of the user session, the administrator is considered to own the user agent, not the user session. A user session can be configured such that it does not have any control over the corresponding user agent, including the user session not being able to disable or otherwise deactivate the user agent. The user agent also can remain hidden from the user session while the user agent is in an idle state. Further, the user agent included in a user session can run automatically until deactivated by the administrator 110. Additionally, the user agent corresponding to a user session can be initialized when the user session is initialized. For example, the user agent can be generated as part of the user session initialization. Alternatively, the user agent can be launched in conjunction with a task associated with the user session, such as execution of a login process.

The host computing system 105 also can include a network interface 145 to a network 150. The network 150 can be a public network, e.g. the Internet, a private network, e.g. a local area network (“LAN”), or a combination thereof. The host computing system 105 can communicate with the first remote system 155 and the second remote system 160 over the network 150. For example, control input received at the first remote system 155 can be transmitted to the host computing system 105 and the first remote user session 115 over the network 150. Further, display data associated with the first remote user session 115 can be transmitted over the network 150 to the first remote system 155 for presentation.

The communication path used by the administrator 110 to communication with a user session can be realized using one or more mechanisms. For example, the communication path 125 used for communication between the first remote user session 115 and the administrator 110 can be realized using a file, a pipe, a socket, or a messaging implementation, such as Mach. Further, the administrator 110 can use the same mechanism or different mechanisms for communication with different user sessions.

In some implementations, a file can be used as a communication path between the administrator and one or more user sessions, such as the communication paths 125 and 130. A file can contain a message that is to be delivered to one or more user sessions. In order to deliver the message, the file can be saved in a storage location accessible to the recipient user sessions. If the message is to be delivered to one or more specific user sessions, the message can be saved to a private or semi-private location, such as a home folder, associated with each of the intended recipients.

Alternatively, if the message is to be delivered to all of the user sessions executing on the host computing system 105, the file can be saved to a shared folder that is accessible to all of the intended recipients. The user agent associated with a user session, such as the user agents 135 and 140, can be configured to monitor one or more directories for the addition of a file. In some implementations, the user agent can be configured to monitor one or more directories for a file matching predetermined criteria, such as name or owner. If the user agent detects the existence of a message file, the user agent can process the message. For example, the user agent can access the file, discard one or more items of configuration data, such as a user identifier (userID), format the message for presentation, and present the message, such as by displaying the message on an associated monitor.

In some other implementations, a Unix/Mac pipe can be used as a communication path between the administrator and one or more user sessions. The administrator can put a message into the pipe for distribution to one or more user sessions. A pipe implements first-in/first-out (FIFO) delivery, so messages will be delivered in the sequence in which they are transmitted. The user agent associated with a user session can turn the pipe on to receive messages. For example, the user agent can turn the pipe on and leave it on during initialization of the user session. Thus, any messages transmitted by the administrator can be immediately presented as they are received. Alternatively, the user agent can periodically turn the pipe on to determine whether any messages are in the pipe and to retrieve the messages from the pipe. Any messages received since the last time the pipe was opened can be accessed, processed, e.g. to remove data that need not be displayed, and presented, such as on an associated monitor.

In some other implementations, a socket can be used as a communication path. The socket can be implemented as a connection that provides communication between two user sessions within the host computing system 105, such as an inter-process communication (IPC) socket or a Unix domain socket (UDS). Once established, messages can be passed over the socket from the administrator to the corresponding user session. The administrator can establish a socket with each user session that will receive a message. Like a pipe, messages are transmitted through the socket in FIFO fashion. The user agent associated with a user session can monitor the socket and receive messages transmitted by the administrator. Messages received over the socket can be accessed, processed, e.g. to remove data that need not be displayed, and presented, such as on an associated monitor.

In some other implementations, messages can be transmitted from an administrator to a user session through a messaging function available in an operating system, such as Mach messaging in the Mac OS X. For example, the user agent associated with a user session can be configured to monitor a port for message traffic from the administrator. Messages received on the port can be accessed, processed, e.g. to remove data that need not be displayed, and presented, such as on an associated monitor.

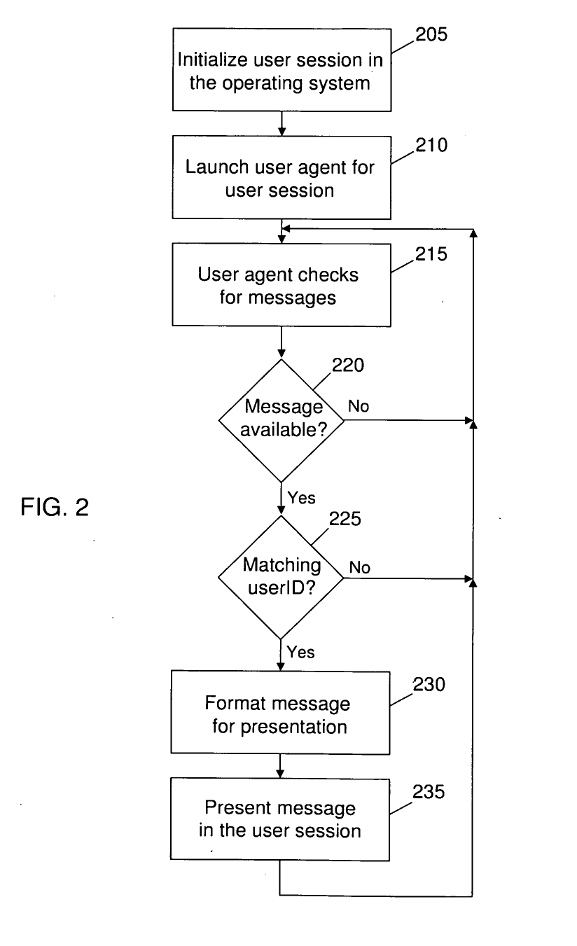

FIG. 2 presents an exemplary process for broadcasting a message to one or more users in a multi-user environment. One or more user sessions can be initialized in an operating system (205). For example, one or more users, including remote users, can login and initiate user sessions on a host computing system. At least one user session can be an administrator session, which can include privileges in excess of those typically granted to user sessions. The administrator session can be permitted to monitor one or more user sessions executing on the host computing system and/or transmit messages to the user sessions.

When a user session is initialized on the host computing system, a user agent corresponding to the user session also can be launched (210). The user agent can be configured to run with one or more privileges in excess of those granted to the user session, such as the ability to open a communication path to receive messages from the administrator. Further, the user agent can run outside of the control of the user session, so that the user session can not disable or otherwise alter the functionality of the user agent. In some implementations, the user agent can belong to the administrator. Additionally, the functionality of the user agent can be constrained to a limited number of tasks to reduce the possibility of using the user agent in an illicit manner.

Once initialized, the user agent can check for messages (215). The user agent can be configured to check for messages periodically, such as by opening a communication path for a limited amount of time. Alternatively, the user agent can open the communication pathway when it is initialized and can keep the communication pathway open for the duration of the user session. Although described for a single user agent, each user agent of the user sessions executing on the host computing system checks for messages while the user session is active.

The user agent determines whether a message is present (220). If no message is present, the user agent continues to monitor the communication pathway for messages. If the user agent detects a message, the user agent can determine whether an identifier, such as a user identification (userID), associated with the message matches the identification, e.g. userID, of the user session (225). The administrator can broadcast a message to one or more user sessions. For example, the administrator can broadcast a system-wide message to all of the user sessions, a group message to a plurality of user sessions, or an individual message to a single user session. The user identification indicates to which user sessions the corresponding message is addressed.

If the identification information does not match, the user agent can discard the message and can continue to monitor the communication pathway for messages. However, if the identification information of the message matches the user session identification, the user agent can format the message for presentation (230). For example, the user agent can discard any information not intended for display, such as the userID. The user agent also can generate a displayable item in the format specified by the message.

The user agent then can present the message in the user session (235). The message can be presented in accordance with one or more rules. For example, the message can be displayed in a window or on-screen text that appears above all other subject matter displayed on the screen. Media information, such as audio, also can be presented in conjunction with or in place of a text-based message. Further, the user agent can continue to present the message for a predetermined amount of time or until a predetermined event, such as user acknowledgement, has occurred. Additionally, while the user session remains active, the user agent continues to monitor the communication path for additional messages from the administrator.

The embodiments described above are given as illustrative examples only. It will be readily appreciated by those skilled in the art that many deviations may be made from the specific embodiments; accordingly, the scope of the invention is to be determined by the claims below rather than being limited to the specifically described embodiments above. In addition, the flowcharts found in the figures are provided to instruct a programmer of ordinary skill to write and debug the disclosed embodiments without undue effort; the logic flow may include other steps and the system other components. The invention is not limited to a particular expression of source or object code. Accordingly, other implementations are within the scope of the claims.

What is claimed:

1. A method for broadcasting a message to one or more user sessions in a terminal server environment, the method comprising:
launching a user agent corresponding to a user session;
monitoring, by the user agent, a communication path;
receiving on the communication path a message from an administrator, the message including a user identifier;
determining, by the user agent, that the included user identifier corresponds to an identification associated with the user session; and
presenting message content associated with the received message in the user session.

2. The method of claim 1, wherein the communication path is the same for two or more user sessions.

3. The method of claim 1, wherein the user agent is controlled by the administrator.

4. The method of claim 3, wherein the user session is not able to deactivate the user agent.

5. The method of claim 1, wherein the user agent corresponding to the user session is automatically launched upon initialization of the user session.

6. The method of claim 1, wherein the communication path is selected from the group comprising a file, a pipe, a socket and a messaging implementation.

7. The method of claim 1, further comprising configuring the user agent to have one or more privileges in excess of those granted to the corresponding user session.

8. A computer network system comprising:
a network host server comprising one or more processing elements, wherein the server is in communication with multiple remote devices;
wherein the one or more processing elements are programmed or adapted to perform the steps comprising:
(i) launching a user agent corresponding to a user session;
(ii) monitoring, by the user agent, a communication path;
(iii) receiving on the communication path a message from an administrator, the message including a user identifier;
(iv) determining, by the user agent, that the included user identifier corresponds to an identification associated with the user session; and
(v) presenting message content associated with the received message in the user session.

9. The system of claim 8, wherein the communication path is the same for two or more user sessions.

10. The system of claim 8, wherein the user agent is controlled by the administrator.

11. The system of claim 10, wherein the user session is not able to deactivate the user agent.

12. The system of claim 8, wherein the user agent corresponding to the user session is automatically launched upon initialization of the user session.

13. The system of claim 8, wherein the communication path is selected from the group comprising a file, a pipe, a socket and a messaging implementation.

14. The system of claim 8, further comprising one or more processing elements programmed or adapted to perform the step of configuring the user agent to have one or more privileges in excess of those granted to the corresponding user session.

15. A tangible computer-readable storage media comprising stored instructions that, upon execution by a programmable processor, are operable to cause the programmable processor to perform the method of claim 1.
